(19) United States
(12) Patent Application Publication
(10) Pub. No.: US 2025/0060016 A1
(43) Pub. Date: Feb. 20, 2025

(54) BRAKE ACTUATOR UNIT, STRAIN SENSOR FOR SUCH A BRAKE ACTUATOR UNIT, AND ELECTROMECHANICAL BRAKE

(71) Applicant: ZF Active Safety GmbH, Koblenz (DE)

(72) Inventor: Volker Knop, Ulmen (DE)

(21) Appl. No.: 18/808,353

(22) Filed: Aug. 19, 2024

(30) Foreign Application Priority Data
Aug. 18, 2023 (DE) 102023122191.4

(51) Int. Cl. F16D 66/00; B60T 13/74; B60T 17/22; F16D 65/18; F16D 121/24; F16D 125/40; F16D 125/50; G01L 1/18

(52) U.S. Cl. CPC F16D 66/00; B60T 13/746; B60T 17/22; F16D 65/18; G01L 1/18; F16D 2066/005; F16D 2121/24; F16D 2125/40; F16D 2125/50

(57) ABSTRACT

A brake actuator unit for an electromechanical brake has a spindle, a spindle bearing, which receives the spindle, and a cup-shaped brake piston bearing section, which has a circumferential wall and a base, against which the spindle bearing is supported axially during the actuation of the brake. The brake actuator unit furthermore has a strain sensor having a sensor element, which is arranged on an outer circumference of an axial section of the circumferential wall and is configured to detect a strain of the axial section in a circumferential direction. Moreover, a strain sensor for a brake actuator unit of this kind is provided. Furthermore, an electromechanical brake having a brake actuator unit of this kind and/or having a strain sensor of this kind is provided.

### CROSS-REFERENCE TO RELATED APPLICATIONS

This application claims priority to German Application No. 102023122191.4, filed on Aug. 18, 2023, the disclosure of which is incorporated herein by reference in its entirety.

### TECHNICAL FIELD

The disclosure relates to a brake actuator unit for an electromechanical brake, having a spindle, a brake piston coupled to the spindle in terms of drive, a spindle bearing, which receives the spindle and absorbs the axial reaction forces of the spindle during the actuation of the brake, and a cup-shaped brake piston bearing section, which has a circumferential wall and a base, against which the spindle bearing is supported axially during the actuation of the brake. The disclosure furthermore relates to a strain sensor for such a brake actuator unit. Furthermore, the disclosure relates to an electromechanical brake having such a brake actuator unit and/or having such a strain sensor.

### BACKGROUND

Brake actuator units of this kind, as well as brakes that have such brake actuator units, are known and are provided for the purpose of decelerating or immobilizing vehicles fitted therewith.

Here, the braking force or application force with which the brake actuator unit acts on a brake disc when the brake is actuated depends on a number of influencing factors, e.g. the friction pad and the spindle drive, and generally changes over the time in use and age of the brake.

In order to ensure a constant effect of the brake over time, it is therefore necessary to control the brake in accordance with the changed influencing factors.

What is needed is a brake actuator unit by which a constant effect of the brake over time can be ensured in a reliable manner.

### SUMMARY

A brake actuator unit for an electromechanical brake is disclosed herein. The brake actuator unit has a spindle, a brake piston coupled to the spindle in terms of drive, a spindle bearing, which receives the spindle and absorbs the axial reaction forces of the spindle during the actuation of the brake, and a cup-shaped brake piston bearing section, which has a circumferential wall and a base, against which the spindle bearing is supported axially during the actuation of the brake. In this case, the brake actuator unit has a strain sensor having at least one sensor element, which is arranged on an outer circumference of an axial section of the circumferential wall and is configured to detect a strain of the axial section in a circumferential direction.

The disclosure has recognized that the base of the cup-shaped brake piston bearing section is subjected via the spindle to an axial reaction force of the application force when the brake is actuated. During this process, this reaction force produces a proportional strain of the axial section, this strain being detected by the at least one sensor element. Due to the strain sensor, it is thus possible to determine the currently acting application force reliably at any time. The brake actuator unit can be controlled in an appropriate manner on the basis of this information in order to ensure a constant effect of the brake, even when influencing factors change.

In one exemplary arrangement, the axial section is adjacent to the base, thereby ensuring that the strain of the axial section is particularly large and can thus be determined very precisely.

In addition to, or as an alternative, the outer circumference of the axial section can be formed by a circular-cylindrical lateral surface, at least in some section or sections. This configuration promotes uniform strain of the outer circumference in the circumferential direction, thus enabling the strain of the axial section to be determined reliably.

In another exemplary arrangement, the at least one sensor element is mounted on a flat surface on the outer circumference of the axial section, which surface extends in the axial direction and in the tangential direction. In this way, the at least one sensor element is secured at a defined location on the outer circumference and is set up to determine the strain of the outer circumference precisely. Moreover, the brake actuator unit is of compact design as a result.

In addition, the strain sensor can have an electrical terminal, which is connected in a signal-transmitting manner to the at least one sensor element, thereby simplifying the assembly of the brake actuator unit.

Provision can furthermore be made for the strain sensor to have a contacting hoop which is annular, at least in some section or sections, and which extends in the circumferential direction around the axial section. In this case, the contacting hoop has a terminal section having the electrical terminal and, on the inner circumference, a contact section with electrical contacts, via which the electrical terminal is connected in a signal-transmitting manner to the at least one sensor element. This enables the assembly of the brake actuator unit to be performed with little effort.

In this arrangement, the contacting hoop can be prestressed in the circumferential direction in such a way that the contacting hoop is pressed radially against the axial section. This ensures reliable contact between the electrical contacts of the contact section and the at least one sensor element.

According to one exemplary arrangement, the contacting hoop has, in the circumferential direction, a gap which separates a first circumferential end from an opposite second circumferential end. In this case, the contacting hoop has a connecting element, which connects the first circumferential end to the second circumferential end in the circumferential direction. This enables the contacting hoop to be installed with little effort and to be prestressed in the circumferential direction in an effective manner.

According to an alternative arrangement, the strain sensor has a flexible cable section, which extends in the circumferential direction around the axial section, at least in some section or sections. In this arrangement, the flexible cable section has electrical leads with electrical contacts, via which the electrical terminal is connected in a signal-transmitting manner to the at least one sensor element. This configuration simplifies the assembly of the brake actuator unit.

In this arrangement, the at least one sensor element can have electrical pin contacts, and the flexible cable section can have a complementary flat socket with the electrical contacts. In this case, the pin contacts and the flat socket form a plug-in connection, thereby enabling assembly to be carried out with particularly little effort. Furthermore, this configuration makes the strain sensor compact.

In addition, provision can be made for the brake actuator unit to have an electronics module having a circuit board and an electrical connecting device, which has electrical connecting leads, each having a first connecting contact and an opposite second connecting contact. In this arrangement, the connecting device is connected in a signal-transmitting manner via the first connecting contacts to the electrical terminal and via the second connecting contacts to the circuit board. In this way, the circuit board is efficiently connected to the strain sensor in a signal-transmitting manner.

In one exemplary arrangement, the electrical terminal is designed as a socket, and the first connecting contacts are designed as plug-in pins, which form a plug connector for the socket. Thus, the brake actuator unit can be assembled with little effort.

Furthermore, the plug connector and the socket can form a plug-in connection with an axial plug-in direction, further simplifying assembly.

In another exemplary arrangement, the second connecting contacts are plug-in compression-connector contact pins, which extend in the axial direction, thereby enabling the second connecting contacts to be connected effectively to the circuit board in a signal-transmitting manner with little effort.

In addition to, or as an alternative, the connecting leads can be formed by a punched grid, which can be produced at particularly low cost. Furthermore, the punched grid is dimensionally stable, thereby simplifying assembly.

In addition, provision can be made for the connecting device to have a step-shaped profile with axial sections and radial sections. This configuration has the advantage that the connecting device extends radially and axially between adjacent component parts of the brake actuator unit, thereby enabling the latter to be configured in a compact way.

According to one exemplary arrangement, the brake actuator unit has a transmission module, which is coupled to the spindle in terms of drive and is arranged between the strain sensor and the electronics module in the axial direction. As a result, the brake actuator unit is of space-saving design.

In this arrangement, the transmission module can have a ring gear and a transmission carrier having a receptacle, in which the connecting device is arranged with positive engagement, at least in some section or sections. In this case, the ring gear is connected by a press fit to the transmission carrier. Furthermore, the connecting device is clamped between the ring gear and the transmission carrier in the axial direction and/or in the radial direction. This configuration enables the brake actuator unit to be produced in a compact form and with little effort.

In addition to, or as an alternative, the strain sensor can be arranged in the radial direction within a transmission housing of the transmission module, thereby making the brake actuator unit of a space-saving configuration. Furthermore, the strain sensor is in this way protected by the transmission housing, and the brake actuator unit is thus of particularly efficient configuration.

According to another exemplary arrangement, the strain sensor has a positioning contour, which is in positive engagement with a complementary positioning contour on the outer circumference of the axial section. As a result, precise arrangement of the strain sensor is ensured and assembly can be carried out with little effort.

Provision can furthermore be made for the cup-shaped brake piston bearing section to be an integral part of a brake housing of the brake actuator unit, as a result of which the brake actuator unit is particularly compact. Furthermore, this makes the brake actuator unit of particularly robust configuration, ensuring that forces which act on the brake actuator unit during the actuation of the brake, as well as vibration while driving, can be absorbed or dissipated in a particularly effective manner. Furthermore, a smaller number of individual components has advantages in terms of logistics and assembly.

In one exemplary arrangement, the brake housing forms a brake calliper, thus improving the structural integrity of the brake actuator unit and suppressing vibration during operation in a particularly effective manner.

According to one aspect, the cup-shaped brake piston bearing section accommodates the brake piston at least partially in a cylindrical socket, and the radial inner side of the circumferential wall forms a sliding guide surface for the brake piston. The brake actuator unit set up in this way advantageously makes it possible to compensate for off-centre force components. The sliding guide surface on the radially inner side of the circumferential wall brings about a restoring force in the direction of the axis of rotation of the spindle. In this way, the orientation and mounting of the individual components of the brake actuator unit, for example, the symmetry with respect to the rotation axis of the spindle, can be improved. Overall, this leads to an improved application of force to the brake piston and to reduced wear.

According to the disclosure, a strain sensor is disclosed that is used with the abovementioned advantages in a brake actuator unit according to the disclosure.

According to the disclosure, the abovementioned object is furthermore achieved by providing an electromechanical brake having an electric motor for actuating the brake, which motor is coupled to the spindle in a torque-transmitting manner, having a brake actuator unit according to the disclosure and/or having a strain sensor according to the disclosure with the abovementioned advantages.

### BRIEF DESCRIPTION OF THE DRAWINGS

Further advantages and features will become apparent from the following description and from the appended drawings. In the drawings:

FIG. 1 shows a longitudinal section through an electromechanical brake according to the disclosure having a brake actuator unit according to the disclosure,

FIG. 2 shows an exploded view of an electromechanical actuating unit of the brake from FIG. 1 with a transmission module,

FIG. 3 shows a perspective view of a brake housing and a sensor element of the brake actuator unit from FIG. 1,

FIG. 4 shows a perspective view of the sensor element from FIG. 3,

FIG. 5 shows a perspective view of the sensor element from FIG. 3 in accordance with an alternative exemplary arrangement,

FIG. 6 shows a top view of the sensor element from FIG. 3 in accordance with another alternative exemplary arrangement,

FIG. 7 shows a bottom view of the sensor element from FIG. 6,

FIG. 8 shows an exploded view of an annular contacting hoop of a strain sensor of the brake actuator unit from FIG. 1,

FIG. 9 shows a perspective view of electrical leads of the contacting hoop from FIG. 8,

FIG. 10 shows an exploded view of the brake housing and the sensor element from FIG. 3 as well as the contacting hoop from FIG. 8,

FIG. 11 shows an exploded view of the brake housing and the contacting hoop from FIG. 10 in an assembled state as well as an electrical connecting device of the brake actuator unit from FIG. 1,

FIG. 12 shows a detail view of the contacting hoop from FIG. 8 and the sensor element from FIG. 10,

FIG. 13 shows an exploded view of the contacting hoop from FIG. 8 in accordance with an alternative exemplary arrangement,

FIG. 14 shows an exploded view of a transmission housing and a ring gear of the transmission module from FIG. 2 as well as the electrical connecting device from FIG. 11,

FIG. 15 shows a perspective view of the transmission housing, the ring gear and the electrical connecting device from FIG. 14 in an assembled state,

FIG. 16 shows a longitudinal section of the path of the electrical connecting device from FIG. 11 from the strain sensor to a circuit board of the electromechanical actuating unit from FIG. 2,

FIG. 17 shows an exploded view of the brake housing from FIG. 3 with the strain sensor of the brake actuator unit from FIG. 1 in accordance with an alternative exemplary arrangement,

FIG. 18 shows an exploded view of the strain sensor from FIG. 17,

FIG. 19 shows an exploded view of the strain sensor from FIG. 17 in accordance with an alternative exemplary arrangement, and

FIG. 20 shows a cross section through a nano-multilayer, by which the brake housing and the sensor element from FIG. 3 are connected to one another.

### DETAILED DESCRIPTION

The following detailed description in conjunction with the appended drawings, in which identical numbers refer to identical elements, is intended as a description of various exemplary arrangements of the disclosed subject matter and is not intended to represent the only embodiments. Any arrangement described in this disclosure is purely by way of example or illustration and should not be construed as preferred or advantageous over other arrangements.

All of the features disclosed below with respect to the exemplary arrangements and/or the accompanying figures can be combined, alone or in any subcombination, with features of the aspects of the present disclosure, including features of exemplary arrangements, provided that the resulting combination of features is worthwhile for a person skilled in the art.

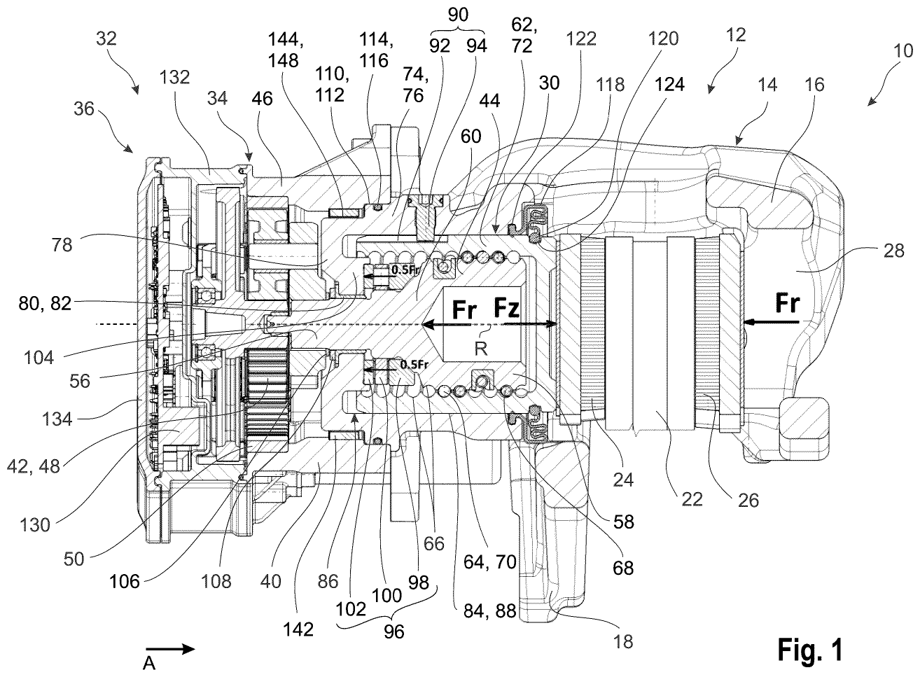

FIG. 1 shows an electromechanical brake 10 having a brake actuator unit 12.

Here, the electromechanical brake 10 is a disc brake for a vehicle and is assigned to a wheel of the vehicle.

The brake actuator unit 12 has a brake housing 14 having a brake calliper 16 and a base support 18, by which the brake 10 is secured on the body of the vehicle.

The brake housing 14 is manufactured, for example, from spheroidal graphite iron, i.e. cast iron containing spheroidal graphite.

In this context, the brake calliper 16 is connected to the base support 18 via linear guides mounted on guide supports 20 (see FIG. 3) and, due to the guides, can be moved in the axial direction A relative to the base support 18 and is therefore mounted in a floating manner.

The brake calliper 16 surrounds a brake disc 22, for example a brake disc rotor, which can be clamped in the axial direction, being gripped by two brake pads 24, 26.

The brake pad 24 which is on the inside in the axial direction A is mounted on the base support 18 in such a way that it can move in the axial direction A.

The brake pad 26 which is on the outside in the axial direction A is mounted on a pad carrier section 28, which is an integral part of the brake calliper 16.

The brake pad 24 which is on the inside along a rotation axis R of the brake actuator unit 12 is subjected actively to an application force Fz by the brake actuator unit 12 when the brake 10 is activated.

In the present case (in the ideal case of compensated transverse forces), the rotation axis R of the brake actuator unit 12 also corresponds to the cylinder axis of the brake housing 14 and the brake disc axis of rotation of the brake disc 22.

The axially movable brake calliper 16 ensures that the brake pad 26 which is on the outside in the axial direction A is likewise acted upon by the application force Fz. In this case, the application force Fz is distributed substantially uniformly in terms of magnitude between the inner brake pad 24 and the outer brake pad 26. Thus, as a result of the contact pressure force provided, frictional engagement with the brake disc 22 can be ensured for both brake pads 24, 26, said engagement being used to decelerate or immobilize the vehicle.

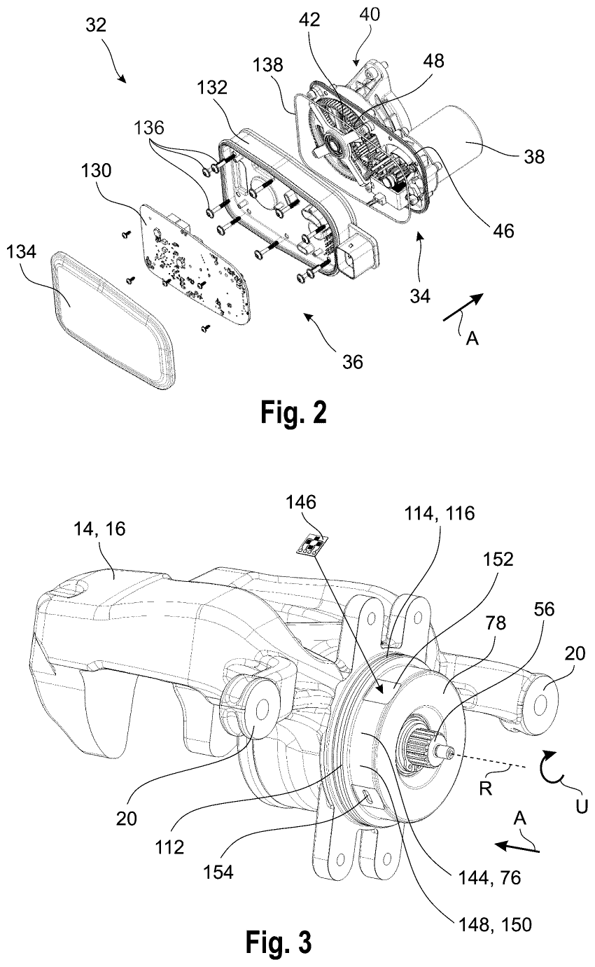

The brake actuator unit 12 furthermore has a positioning device 30 and an electromechanical actuating unit 32 (see FIG. 2) having a transmission module 34 and an electronics module 36.

In this case, the positioning device 30 and the transmission module 34 are set up to produce the application force Fz together with an electric motor 38 (see FIG. 2).

With the electric motor 38, the electromechanical actuating unit 32 forms a closed subassembly that can be assembled separately.

The transmission module 34 has a transmission housing 40 and a transmission 42, which connects the electric motor 38 to a spindle 44 (see FIG. 1) of the positioning device 30 in terms of drive.

The transmission housing 40 has an integral transmission carrier 46, on which the transmission 42 is secured or mounted.

In the exemplary arrangement under consideration, the transmission housing 40 is of one-piece configuration and forms an external housing of the transmission module 34.

Furthermore, the transmission housing 40 can be formed from plastic, for example a fibre-reinforced plastic, or a light metal, e.g. an aluminium alloy.

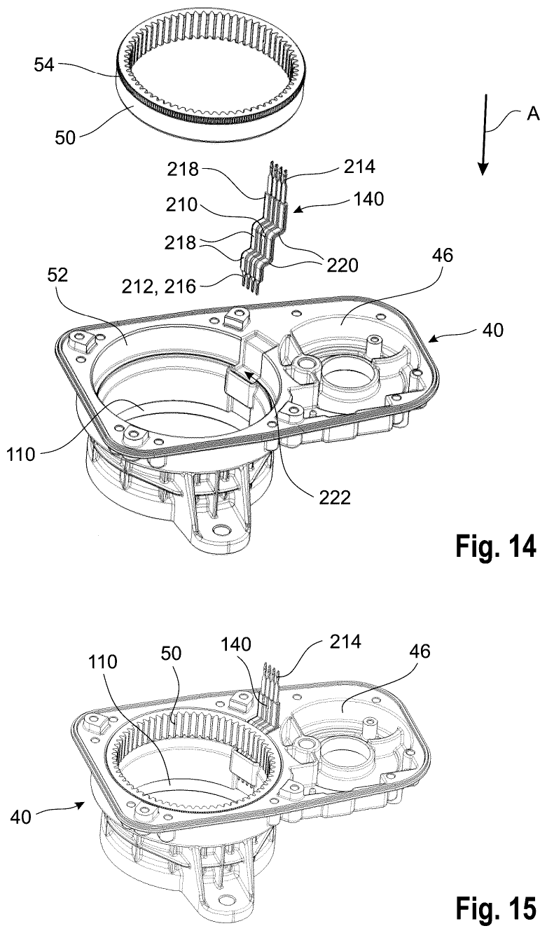

Here, the transmission 42 is a multistage reduction gear and comprises a planetary transmission 48 comprising a ring gear 50 (see FIG. 14).

The ring gear 50 is manufactured from metal, such as, for example, sintered metal.

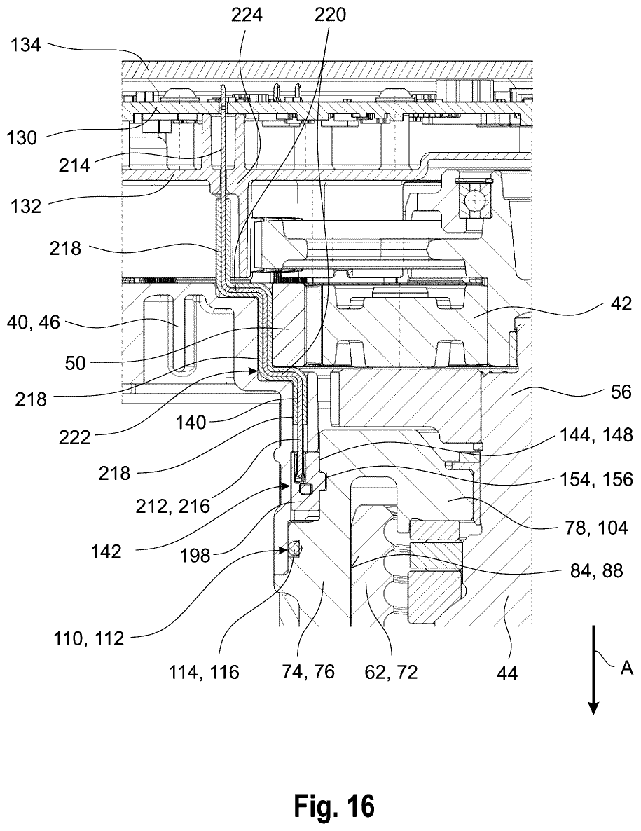

In the exemplary arrangement under consideration, the ring gear 50 is arranged in a cylindrical socket 52 (see FIG. 14) of the transmission carrier 46, and is secured by a press fit with interference and a knurled connection on the transmission carrier 46 (see FIG. 15).

To form the knurled connection, the ring gear 50 has a knurled outer circumferential section 54.

In an alternative exemplary arrangement, the ring gear 50 is embedded in the transmission carrier 46 by overmoulding, which is then manufactured from plastic, in particular.

The play-free press fit between the ring gear 50 and the cylindrical socket 52 ensures effective centring and alignment of the ring gear 50 with the transmission carrier 46.

Furthermore, the knurled connection ensures an effective safeguard against rotation of the ring gear 50 in the transmission carrier 46 by positive engagement, even at high temperatures.

In the exemplary arrangement under consideration, the transmission 42 is coupled in a torque-transmitting manner to the positioning device 30 via a drive shaft extension 56 (see FIG. 3), which is arranged at one axial end of the spindle 44.

The spindle 44 furthermore has a shank section 58 on the brake-pad side (see FIG. 1) and a transitional section 60, which is arranged between the drive shaft extension 56 and the shank section 58 along the rotation axis R of the spindle 44. The outside diameter of the drive shaft extension 56 of the brake actuator unit 12 is smaller along the radial direction than the outside diameter of the shank section 58 along this direction. The spindle 44 tapers correspondingly with respect to its outside diameter in the region of the transitional section 60.

The positioning device 30 furthermore has a spindle nut 62 secured against rotation and a spindle drive 64, which, in the present case, is designed as a recirculating ball screw and is free from self-locking. The spindle drive 64 comprises a thread 66, in which balls 68 are arranged and roll. The spindle 44 and the spindle nut 62 have mutually corresponding race parts, which together form the thread 66. The balls 68 can permit a translational movement of the spindle nut 62 along the rotation axis R with respect to the spindle 44 along the ball races 70 of the thread 66. For this purpose, the ball races 70 are formed at least partially in the shank section 58 of the spindle 44 and of the spindle nut 62.

The diameter of the ball races 70 corresponds to the diameter of the balls 68, taking into account manufacturing tolerances and required gap dimensions.

In the exemplary arrangement under consideration, the spindle nut 62 forms a brake piston 72 of the brake actuator unit 12.

In an alternative exemplary arrangement, the brake piston 72 and the spindle nut 62 are separate component parts which are coupled to one another in terms of drive.

As a result of the translational movement of the spindle nut 62 in the direction of the brake disc 22, the spindle nut 62 or the brake piston 72 is moved in the direction of the inner brake pad 24 and thus ensures the active application of the application force Fz to the inner brake pad 24.

Here, the rotation of the spindle 44 is ensured by the electric motor 38, which is in engagement with the drive shaft extension 56 of the spindle 44 via the transmission 42. The gradients of the spindle drive 64, in particular of the ball races 70, and the blocking of a rotary motion of the spindle nut 62 then have the effect that the rotation of the spindle 44 brings about a translational movement of the spindle nut 62. This movement is transmitted to the brake pads 24, 26 via the spindle nut 62 or brake piston 72.

The generated application force Fz is proportional to the torque which is produced at the drive shaft extension 56 by the electric motor 38 and the transmission 42.

In this context, the brake calliper 16 has a cup-shaped brake piston bearing section 74 having a circumferential wall 76, which extends along the rotation axis R, and a base 78, which extends radially from the circumferential wall 76 towards the rotation axis R. The open end of the cup-shaped brake piston bearing section 74 is arranged on the brake-pad side along the rotation axis R. This means that the base 78 is arranged at the opposite end of the brake piston bearing section 74 from the brake disc 22. The base 78 has a through-hole 80 for the drive shaft extension 56 of the spindle 44, which is held therein by a radial bearing 82.

In the exemplary arrangement under consideration, the brake calliper 16 is of one-piece design.

In principle, the brake calliper 16 can be formed from a plurality of individual components but, in all the arrangements of the brake piston bearing section 74, it is connected integrally to the pad carrier section 28.

The base 78 and the circumferential wall 76, to be more precise the radial inner side 84 of the circumferential wall 76, delimit a cylindrical socket 86, in which the spindle 44 and the spindle nut 62 or brake piston 72 are at least partially arranged. Owing to the linear mobility of the spindle nut 62 or brake piston 72, these components may also be arranged at least partially outside the cylindrical socket 86.

In this arrangement, the inner side 84 forms a sliding guide surface 88 for the spindle nut 62 or brake piston 72, against which surface the spindle nut 62 or brake piston 72 rests, at least in some section or sections, and is guided by it.

As already mentioned, the spindle nut 62 is guided linearly and secured against rotation with respect to the brake piston bearing section 74 within the cylindrical socket 86 by means of a rotary lock 90.

For this purpose, the spindle nut 62 has, on the outer circumference, an axial groove 92, which is in engagement with a pin 94 that projects radially into the cylindrical socket 86 from the inner side 84 of the circumferential wall 76 in order to form the rotary lock 90.

In the exemplary arrangement illustrated, the pin 94 is formed by a screw, which extends in the radial direction through the circumferential wall 76.

This rotary lock 90 is necessary especially when contact between the spindle nut 62 or brake piston 72 and a carrier of the inner brake pad 24 has not been established. Once contact has been established between the spindle nut 62 or brake piston 72 and the carrier of the inner brake pad 24 or the carrier thereof, the application force Fz generates a friction torque which secures the spindle nut 62, for example against rotation.

The application force Fz generated is proportional to the axial stroke of the spindle nut 62. Here, the proportionality factor corresponds to the instantaneous system stiffness. The axial stroke of the spindle nut 62 furthermore compensates the friction pad wear.

As a result of the generated application force Fz, a reaction force Fr, which is opposite to the application force Fz, occurs along the rotation axis R. Owing to the elastic expansion of the components of the brake 10, an angular misalignment can generally occur between the brake disc axis of rotation and the cylinder axis of the brake housing 14, with the result that the reaction force Fr has off-centre force components. These off-centre force components can lead to instability of the components of the brake actuator unit 12 along the radial direction, particularly if the core diameter of the spindle drive 64 is smaller than the outside diameter of a bearing which is intended to absorb the reaction force Fr.

In the present case, therefore, the brake actuator unit 12 comprises a rotationally symmetrical spindle bearing 96 (see FIG. 1) embodied as an axial bearing with a bearing ring 98 which has a spherical bearing contact surface arranged on the brake-pad side. The spindle bearing 96 is in contact with the conical transitional section 60 of the spindle 44, which has a contact surface complementary to the spherical bearing contact surface.

The bearing ring 98 furthermore has a flat contact surface, which is arranged opposite the spherical bearing contact surface along the rotation axis R.

Furthermore, the brake actuator unit 12 has rolling elements 100, which are in contact with the bearing ring 98 via the flat contact surface.

Arranged between the rolling elements 100 and the base 78 of the brake piston bearing section 74 there is, in addition, a bearing disc 102, which has opposite flat contact surfaces along the rotation axis R and is pressed into the base 78 so as to be rotationally secure by frictional and/or positive engagement. One of the contact surfaces of the bearing disc 102 is in contact with the base 78. The rolling elements 100 roll on the other of the two contact surfaces of the bearing disc 102.

Thus, the reaction force Fr which occurs is transmitted from the spindle 44, via the transitional section 60, to the spherical bearing contact surface of the spindle bearing 96, and from there is absorbed by the base 78 of the brake piston bearing section 74 via the rolling elements 100 and the bearing disc 102. In other words, the axial reaction force Fr of the spindle 44 during the application of the brake 10 is introduced via the spindle bearing 96 into the base 78.

In principle, it is possible, in an alternative embodiment, for the spindle bearing 96 embodied as an axial bearing to be configured in any desired way.

In this context, the base 78 has an axial, annular, projecting pedestal 104, which projects axially into the cylindrical socket 86 while being spaced apart from the inner side 84 of the circumferential wall 76 by a gap. This enables the spindle bearing 96 to be arranged in the initial position in an internal bore of the spindle nut 62, thereby ensuring a reduction in the axial length of the positioning device 30.

In this arrangement, the spindle nut 62 can project partially axially into the gap between the axial pedestal 104 and the inner side 84 of the circumferential wall 76.

The drive shaft extension 56 of the spindle 44 is supported radially by the radial bearing 82.

The radial bearing 82 has a collar, which acts as an axial stop or axial bearing on one side and which is supported by the outer wall of the base 78, said outer wall being arranged opposite the cylindrical socket 86.

The radial bearing 82 advantageously consists of plastic, thereby making it possible to provide stop damping in order to reduce noise.

The brake actuator unit 12 furthermore has an assembly including a retaining ring 106, which is snapped into a groove in the spindle 44, and a shim 108, which transmits unilateral axial forces from the spindle 44 to the collar of the radial bearing 82. The assembly prevents a unilateral translational movement of the spindle 44 in the direction of the spindle nut 62. Moreover, the retaining ring 106 positions the transmission 42 on one side in the axial direction A on the spindle 44.

In order to centre the transmission 42 with respect to the brake piston bearing section 74, the transmission housing 40 has a centring through-hole 110, which is connected positively to a centring collar 112 of the brake calliper 16.

In this case, the centring through-hole 110 and the centring collar 112 extend in the axial direction A and are arranged coaxially with one another and with the rotation axis R.

In the exemplary arrangement under consideration, the centring collar 112 is arranged on the outer circumference of the brake piston bearing section 74.

In principle, the centring collar 112 can be secured at any desired location on the brake calliper 16, for example on any desired outer circumference.

The centring collar 112 has an encircling groove 114, in which a seal 116 is arranged. In this arrangement, the seal 116 seals the transmission housing 40 statically with respect to the brake calliper 16 and thus prevents the penetration of moisture and foreign particles from the environment into the brake actuator unit 12.

In this context, the brake actuator unit 12 has a bellows 118, which prevents the penetration of moisture and foreign particles from the environment into the spindle drive 64 over the entire stroke of the spindle nut 62. For this purpose, the bellows 118 has two cylindrical sealing beads 120, 122 at its opposite ends. An inner sealing bead 120 is slotted under prestress into an encircling outer groove 124 on the spindle nut 62. The outer sealing bead 122 is slotted into an encircling inner groove in the inner side 84 of the circumferential wall 76 and provides a dynamic seal with respect to the outside diameter of the spindle nut 62.

The transmission housing 40 is fixed directly on the brake calliper 16 in the axial direction A and the tangential direction by positive and frictional engagement by at least two prestressed screws.

Due to this screwed connection, all the reaction forces and reaction torques generated by the electric motor 38 and the transmission 42 during the generation of a driving torque on the spindle 44 are transmitted directly from the transmission housing 40 to the brake calliper 16.

Furthermore, the transmission housing 40 supports all the reaction forces and reaction torques occurring during the action of vibration and transmit them to the brake calliper 16.

In this case, the transmission housing 40 is in force and torque equilibrium with the brake calliper 16.

Furthermore, the screwed connection between the transmission housing 40 and the brake calliper 16 provides a safeguard against rotation and axial fixing of the transmission module 34 on the brake calliper 16.

To control the electric motor 38, the electronics module 36 has a circuit board 130, which is connected in a signal-transmitting manner to the electric motor 38.

The circuit board 130 is arranged in an electronics housing 132 of the electronics module 36, said housing being sealed in an airtight manner by a cover 134.

The electronics module 36 is secured on the transmission housing 40 via the electronics housing 132 by connecting screws 136 (see FIG. 2) and is connected in an airtight manner to the transmission module 34 by a packing cord 138.

In this arrangement, the electronics housing 132 forms a kind of cover or cap for the transmission housing 40.

In this context, the brake actuator unit 12 has a strain sensor 142, which is connected in a signal-transmitting manner to the circuit board 130 or via an electrical connecting device 140 (see FIG. 16) and is set up to detect the resulting proportional strain of the brake piston bearing section 74 in the circumferential direction U (see FIG. 3) when the axial reaction force Fr of the spindle 44 (see FIG. 1) is introduced into the base 78 via the spindle bearing 96 during the application of the brake 10.

To be more precise, the strain sensor 142 is set up to determine the strain in the circumferential direction U of an axial section 144 of the brake piston bearing section 74, on which a sensor element 146 (see FIG. 3) of the strain sensor 142 is arranged.

In this arrangement, the axial section 144 is adjacent to the base 78 in the radial direction.

Furthermore, the axial section 144 extends in the axial direction A between the transmission 42 (see FIG. 1) and the centring collar 112 and, as a result, is arranged radially within the transmission housing 40.

In the exemplary arrangement illustrated, the strain sensor 142 is arranged radially entirely within the transmission housing 40 and is thus protected by the latter with respect to the outside.

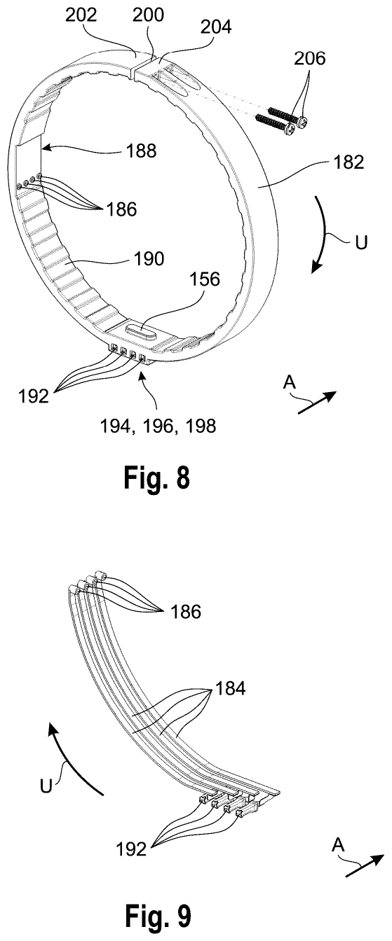

In addition, the axial section 144 has, on the outer circumference 148, a circular-cylindrical lateral surface 150 (see FIG. 3), which is interrupted by a flat surface 152, on which the sensor element 146 is secured, and a positioning contour 154, which is of complementary configuration to a positioning contour 156 (see FIG. 8) of the strain sensor 142.

In this arrangement, the flat surface 152 extends in the axial direction A and tangentially with respect to a virtual circular-cylindrical lateral surface (not illustrated), the radius of which is somewhat smaller than the radius of the circular-cylindrical lateral surface 150.

Here, the positioning contour 154 is formed in part by a flat surface similar to flat surface 152.

In principle, however, the positioning contour 154 can be of any desired configuration.

The sensor element 146 is, for example, a strain-sensitive sensor produced by means of thin-film technology.

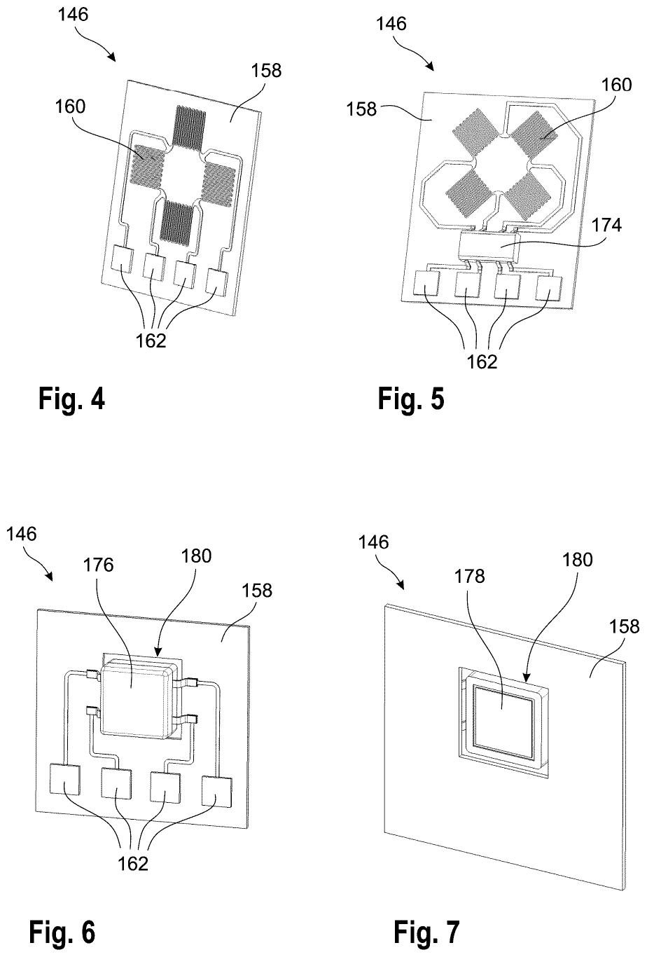

In the exemplary arrangement under consideration, the sensor element 146 (see FIG. 4) has a flat carrier board 158, which, for example, includes a 0.2 mm thick steel sheet, and is coated on one side with an approximately 6 μm thick electrical insulating layer, which consists of alumina ceramic (Al₂O₃), for example.

During production, the surface of the carrier board 158 is polished before coating. The coating of alumina ceramic can be applied by plasma spraying.

The electrical insulating layer has a 10 μm thick strain-sensitive, electrically conductive meandering metal coating 160 on one side.

The meandering metal coating 160 consists, for example, of an NiCr precision resistance alloy and can be formed by physical vapour deposition.

Furthermore, the meandering metal coating 160 is connected up segmentally to form a Wheatstone half bridge or full bridge and oriented in such a way that either longitudinal and transverse strains or sheer strains can be detected, with temperature-related strains being compensated.

The microstructure of the meandering metal coating 160 can be formed by photolithography and subsequent wet-chemical etching or by laser machining.

For the purpose of external contacting, the sensor element 146 has several, e.g. three or four, contact blocks 162, which are mounted on the carrier board 158 and are connected to the meandering metal coating 160 in a signal-transmitting manner.

The carrier board 158 is connected by its rear side, i.e. the side arranged opposite the side on which the contact blocks 162 are mounted, to the flat surface 152 by what is referred to as bonding.

In bonding, a reactive film 164 (see FIG. 20) is laid between the carrier board 158 and the outer circumference 148 of the axial section 144 and is subjected to a joining pressure.

The surfaces to be connected are optionally pre-soldered or coated with a joining layer 166.

The reactive film 164 consists of a reactive nano-multilayer 168, which has a multiplicity of alternating individual layers of metal or semi-metal with a thickness of a few nanometres.

Due to an electric spark 170 or of a laser, the reactive film 164 is ignited, i.e. an activation energy acts on the reactive nano-multilayer 168. This results in an exothermic reaction in the layers, which propagates in the form of a reaction zone 172 in propagation direction B. Due to the high heat of reaction which is released during this process, which is restricted to a local area, the axial section 144 and the carrier board 158 and/or the optional joining layer 166 are melted and thus converted to the joined state, which is illustrated on the left of the reaction zone 172 in FIG. 20.

This joining method can be automated and has a short process time of less than one second.

The strains of the brake piston bearing section 74 which occur as the brake 10 is applied are transmitted to the carrier board 158 secured on the outer circumference 148 of the axial section 144 (see FIG. 4). Here, the strains are proportional to the magnitude of the reaction force Fr. As a result, the meandering metal coating 160 on the carrier board 158 is strained in a corresponding fashion and consequently the electrical resistance of the meandering metal coating 160 changes. Here, the change in the resistance of the measuring bridge is proportional to the strain.

To enable the strain to be detected, the meandering metal coating 160 is brought into contact with a constant supply voltage and a resistance-dependent signal voltage via the contact blocks 162. Here, the signal voltage is proportional to the strain.

In one exemplary arrangement, the signal voltage can be amplified by a signal amplifier (not illustrated), which is mounted on the carrier board 158 in addition.

In another exemplary arrangement (see FIG. 5), a SENT (Signal Edge Nibble Transmission) interface mounted on the carrier board 158 is provided, which provides the output signal in digital form. In this case, the sensor element 146 has an electronic evaluation chip 174 with an application-specific integrated circuit (ASIC), which is mounted on the carrier board 158. In this arrangement, the meandering metal coating 160 is brought into contact with a constant supply voltage. Furthermore, the evaluation chip can be brought into contact with the meandering metal coating 160 by bonding.

In another exemplary arrangement (see FIG. 6), the sensor element 146 is designed as a strain-sensitive MEMS sensor (MEMS=Micro-Electro-Mechanical Systems), which is based on the piezoresistive effect. In this case, the sensor element 146 has a measuring chip 176, which has a silicon chip with a microelectromechanical measuring bridge and an electronic evaluation circuit (ASIC). The microelectromechanical measuring bridge consists of four measuring resistors, which are diffused into the silicon chip. In this case, the metallic nanoparticles are incorporated into the silicon matrix, with the piezoresistive properties of silicon being exploited. The measuring resistors are connected to form a Wheatstone full bridge.

The measuring chip 176 is connected on its underside (see FIG. 7) by bonding to a substrate 178 that includes stainless steel. An electrical insulating layer is applied to the substrate 178. In this exemplary arrangement, the carrier board 158 has a cutout 180, via which the substrate 178 is connected directly to the outer circumference 148 of the axial section 144 by bonding. In this arrangement, the carrier board 158 is likewise connected to the outer circumference 148 of the axial section 144 by bonding.

In this exemplary arrangement, the strains which occur at the outer circumference 148 of the axial section 144 as the brake 10 is applied are transferred via the substrate 178 to the measuring chip 176. The electrical resistance of the four resistors of the measuring bridge changes in accordance with the piezoresistive effect. In this case, the output voltage or output signal of the measuring chip 176 is a measure of the strain which occurs at the outer circumference 148 of the axial section 144 and hence a measure of the instantaneously generated application force.

In an alternative arrangement, the sensor element 146 can be of any desired configuration as long as it is set up to detect the strain of the axial section 144, for example in the circumferential direction U.

In addition or as an alternative, the sensor element 146 can be secured at any desired location on the outer circumference 148 of the axial section 144.

In an alternative arrangement, the sensor element 146 can furthermore be mounted in any desired manner on the outer circumference 148 of the axial section 144.

During operation, the signal voltage or output voltage of the sensor element 146 is used by a control unit (ECU), which is part of the circuit board 130, as an input variable for the manipulated variable comprising the application force. In this case, the instantaneous actual value is continuously compared with the setpoint value.

In order to ensure stable, trouble-free contact between the sensor element 146 and the circuit board 130, which is required for a continuous signal-transmitting connection, the strain sensor 142 has an annular contacting hoop 182 (see FIG. 8) made of plastic, in which electrical leads 184 (see FIG. 9) made of metal are encapsulated.

In this arrangement, the contacting hoop 182 and the electrical leads 184 extend in the circumferential direction U.

At one end, the electrical leads 184 have electrical contacts 186 in the form of contact cylinders, which project radially inwards from the contacting hoop 182 in a contact section 188 (see FIG. 8) on the inner circumference 190 of the contacting hoop 182.

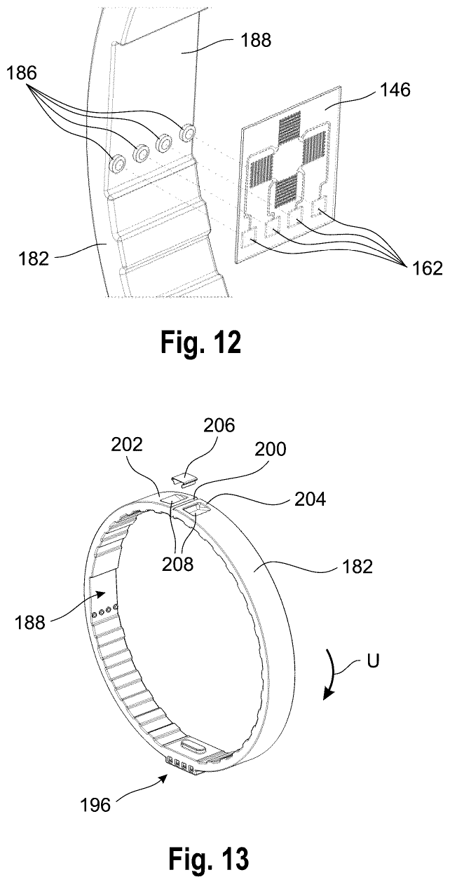

In this case, the electrical contacts 186 (see FIG. 12) are arranged in such a way that they are each situated directly opposite a contact block 162 of the sensor element 146 in the radial direction and make contact therewith in a signal-transmitting manner.

At the other end, the electrical leads 184 are connected to sprung socket contacts 192 (see FIG. 9), which form an electrical terminal 194 (see FIG. 8) of the strain sensor 142.

In this arrangement, the socket contacts 192 are arranged in a terminal section 196 of the strain sensor 142 to form a socket 198, which has a plug-in direction in the axial direction A.

In this context, the positioning contour 156 is arranged in the terminal section 196.

Here, the contacting hoop 182 is in one piece, but this may also be different.

In the exemplary arrangement illustrated, the contacting hoop 182 has a gap 200, which separates a first circumferential end 202 from a second circumferential end 204, situated opposite in the circumferential direction U, of the contacting hoop 182, and two connecting elements 206, by means of which the circumferential ends 202, 204 are connected to one another.

Here, the connecting elements 206 are screws, which, together with a corresponding thread in the first circumferential end 202, form a screwed connection by which the contacting hoop 182 can be prestressed in the circumferential direction U.

In an alternative arrangement (see FIG. 13), the contacting hoop 182 has a connecting element 206 in the form of a spring clip, which is in engagement with correspondingly configured cutouts 208 in the contacting hoop 182 and in this way connects together and pre-stresses the circumferential ends 202, 204 in the circumferential direction U.

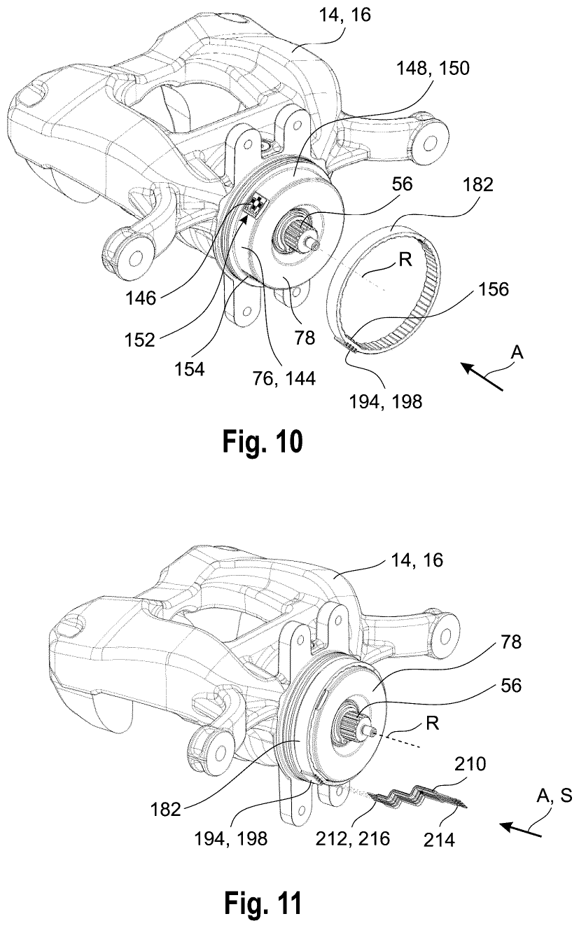

During the assembly of the brake actuator unit 12, the contacting hoop 182 is mounted in the axial direction A on the brake piston bearing section 74 (see FIG. 10), on which the sensor element 146 has already been secured, with the result that the positioning contour 156 of the contacting hoop 182 engages positively in the complementary positioning contour 154 on the outer circumference 148 of the axial section 144. As a result, the contacting hoop 182 is arranged in a defined manner on the brake piston bearing section 74 in the axial direction A and in the circumferential direction U (see FIG. 11). For example, electrical contacts 186 are arranged directly opposite the contact blocks 162 of the sensor element 146 and make contact with said blocks.

For axial mounting, the circumferential ends 202, 204 are spread apart elastically in the circumferential direction U, such that the diameter of the contacting hoop 182 is temporarily enlarged in a corresponding manner.

In a following step, the circumferential ends 202, 204 are pulled towards one another in the circumferential direction U by the connecting elements 206, as a result of which the contacting hoop 182 is clamped firmly on the outer circumference 148 of the axial section 144 in the radial direction, and the electrical contacts 186 rest under prestress against the contact blocks 162 of the sensor element 146.

In this way, the sensor element 146 is connected in a signal-transmitting manner to the electrical terminal 194 of the strain sensor 142.

In this context, the electrical connecting device 140 (see FIG. 16), which connects the strain sensor 142 to the circuit board 130 in a signal-transmitting manner, has electrical connecting leads 210 (see FIG. 14) which each have, at one end, a first connecting contact 212 designed as a plug-in pin and, at the opposite end, a second connecting contact 214 designed as a plug-in compression-connector contact pin.

The number of connecting leads 210 corresponds, for example, to the number of contact blocks 162, which, in the present case, is four.

Here, the connecting leads 210 are formed by a punched grid, which is encapsulated with a plastic in some section or sections.

In an alternative arrangement, it is possible, in principle, for the connecting leads 210 to be configured in any desired manner.

In the exemplary arrangement illustrated, the first connecting contacts 212 form a plug connector 216, which is of complementary configuration to the socket 198 (see FIG. 11) of the strain sensor 142 and is connected in a signal-transmitting manner to the latter via a plug-in connection with an axial plug-in direction S.

Here, the contacting out the plug connector 216 with the socket 198 is performed blind during the mounting of the electromechanical actuating unit 32 on the brake housing 12.

The electrical connecting device 140 furthermore extends in a step shape in profile (see FIG. 16), with axial sections 218 and radial sections 220, from the strain sensor 142, via the transmission carrier 46 and through the electronics housing 132 to the circuit board 130.

For this purpose, the transmission carrier 46 has a step-shaped receptacle 222 (see FIG. 14), in which the connecting device 140 is received with positive engagement.

In this case, the connecting device 140 is clamped firmly by positive and nonpositive engagement in the axial, radial and tangential directions by the ring gear 50 pressed into the transmission carrier 46 (see FIG. 15).

The second connecting contacts 214 extend in the axial direction A, via an alignment guide 224 (see FIG. 16), through the electronics housing 132 and into the circuit board 130, to which they are connected in a signal-transmitting manner by plug-in contacts, which are of complementary configuration to the plug-in compression-connector contact pins.

The contacting between the second connecting contacts 214 and the circuit board 130 is accomplished by pressing in axially. In this case, the reaction force of the press in force is supported on the transmission carrier 46 by the step-shaped connecting device 140.

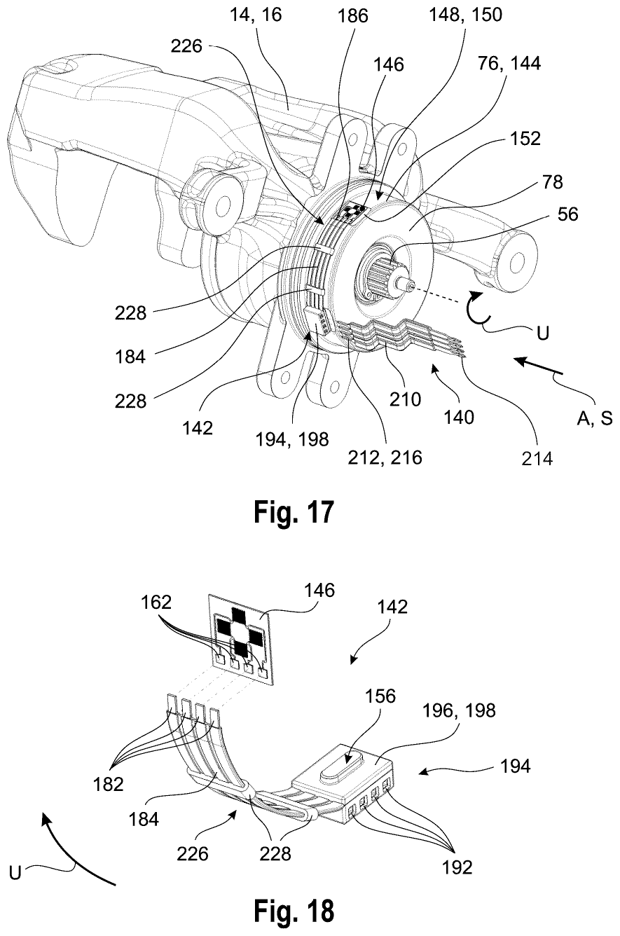

A brake actuator unit 12 having a strain sensor 142 according to an alternative embodiment is now described with reference to FIGS. 17 and 18. The same reference signs are used for the component parts that are known from the above exemplary arrangement, and to this extent reference is made to the preceding explanations.

In contrast to the strain sensor 142 shown in FIG. 8, the strain sensor 142 in the arrangement under consideration does not have a contacting hoop 182 but a flexible cable section 226, which extends from the terminal section 196 to the sensor element 146 in the circumferential direction U along the axial section 144.

In this case, the flexible cable section 226 comprises the electrical leads 184, the electrical contacts 186 of which are connected in a signal-transmitting manner to the contact blocks 162 of the sensor element 146 by bonding or by soldering.

In the arrangement illustrated, the flexible cable section 226 is guided on the outer circumference 148 of the axial section 144. For this purpose, spacers 228 consisting of an elastomer are moulded onto the flexible cable section 226, said spacers holding the flexible cable section 226 at a defined distance from the axial section 144 of the brake piston bearing section 74 and to the inner circumference of the transmission housing 40. Chafing through of the flexible cable section 226 is thereby avoided.

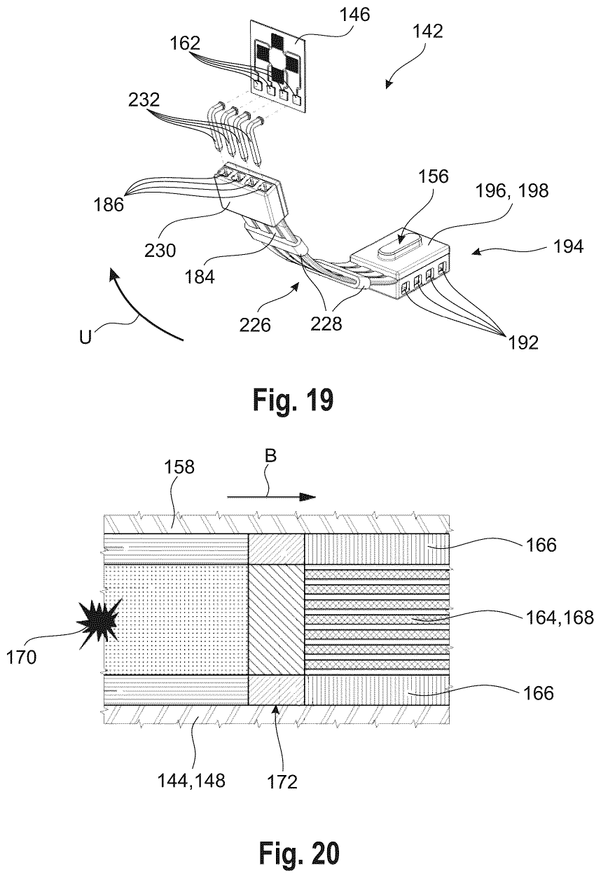

A strain sensor 142 according to another alternative arrangement is now described with reference to FIG. 19. The same reference signs are used for the component parts that are known from the above arrangement, and to this extent reference is made to the preceding explanations.

In contrast to the strain sensor 142 shown in FIGS. 17 and 18, the strain sensor 142 in the embodiment under consideration has a flat socket 230, in which the electrical contacts 186 of the electrical leads 184 form sprung socket contacts or are connected to the latter in a signal-transmitting manner.

Pin contacts 232 in the form of fork-type contact pins are mounted on the contact blocks 162 of the sensor element 146 by bonding or soldering.

In this arrangement, the pin contacts 232 form a plug connector which is of complementary configuration to the flat socket 230 and forms a plug-in connection with the latter. Via this plug-in connection, the sensor element 146 is connected in a signal-transmitting manner to the electrical terminal 194.

In all these exemplary arrangements, a brake actuator unit 12 and an electromechanical brake 10 having a brake actuator unit 12 which in each case has a strain sensor 142, by means of which the strains at the outer circumference 148 of the brake piston bearing section 74 due to the action of the reaction force Fr of the application force Fz can be measured, are provided in this way. It is thus possible to detect the instantaneously generated application force Fz directly.

Due to the instantaneously generated application force Fz it is possible to detect mechanical changes in the efficiency of the multistage transmission 42, of the spindle bearing 96 and of the spindle drive 64, in particular as a function of the power consumption of the electric motor 38, which is detected by a power consumption sensor, for example.

This enables the electric motor 38 to be controlled accordingly in order to ensure a constant effect of the brake 10 over its service life.

Moreover, the brake actuator unit 12 is of compact design.

1. A brake actuator unit for an electromechanical brake, comprising a spindle, a brake piston coupled to the spindle, a spindle bearing, which receives the spindle and absorbs axial reaction forces of the spindle during the actuation of the brake, and a cup-shaped brake piston bearing section, which has a circumferential wall and a base, against which the spindle bearing is supported axially during the actuation of the brake, wherein the brake actuator unit has a strain sensor having at least one sensor element, which is arranged on an outer circumference of an axial section of the circumferential wall and is configured to detect a strain of the axial section in a circumferential direction.

2. The brake actuator unit according to claim 1, wherein the axial section is adjacent to the base.

3. The brake actuator unit according to claim 1, wherein the outer circumference of the axial section is formed by a circular-cylindrical lateral surface, at least in some section or sections.

4. The brake actuator unit according to claim 1, wherein the at least one sensor element is mounted on a flat surface on the outer circumference of the axial section, which surface extends in an axial direction and in a tangential direction.

5. The brake actuator unit according to claim 1, wherein the strain sensor has an electrical terminal, which is connected in a signal-transmitting manner to the at least one sensor element.

6. The brake actuator unit according to claim 1, wherein the strain sensor has a contacting hoop which is annular, at least in some section or sections, and which extends in the circumferential direction around the axial section, wherein the contacting hoop has a terminal section having an electrical terminal and, on an inner circumference, a contact section with electrical contacts, via which the electrical terminal is connected in a signal-transmitting manner to the at least one sensor element.

7. The brake actuator unit according to claim 6, wherein the contacting hoop is prestressed in the circumferential direction in such a way that the contacting hoop is pressed radially against the axial section.

8. The brake actuator unit according to claim 6, wherein the contacting hoop has, in the circumferential direction, a gap which separates a first circumferential end from an opposite second circumferential end, wherein the contacting hoop has a connecting element, which connects the first circumferential end to the second circumferential end in the circumferential direction.

9. The brake actuator unit according to claim 1, wherein the strain sensor has a flexible cable section, which extends in the circumferential direction around the axial section, at least in some section or sections, wherein the flexible cable section has electrical leads with electrical contacts, via which an electrical terminal is connected in a signal-transmitting manner to the at least one sensor element.

10. The brake actuator unit according to claim 9, wherein the at least one sensor element has electrical pin contacts, and the flexible cable section has a complementary flat socket with the electrical contacts, wherein the pin contacts and the flat socket form a plug-in connection.

11. The brake actuator unit according to claim 5, wherein the brake actuator unit has an electronics module having a circuit board and an electrical connecting device, which has electrical connecting leads, each electrical connecting lead having a first connecting contact and an opposite second connecting contact, wherein the connecting device is connected in a signal-transmitting manner via the first connecting contacts to the electrical terminal and via the second connecting contacts to the circuit board.

12. The brake actuator unit according to claim 11, wherein the electrical terminal is designed as a socket, and the first connecting contacts are designed as plug-in pins, which form a plug connector for the socket.

13. The brake actuator unit according to claim 12, wherein the plug connector and the socket form a plug-in connection with an axial plug-in direction(s).

14. The brake actuator unit according to claim 11, wherein the second connecting contacts are plug-in compression-connector contact pins, which extend in the axial direction.

15. The brake actuator unit according to claim 11, wherein the connecting leads are formed by a punched grid.

16. The brake actuator unit according to claim 11, wherein the connecting device has a step-shaped profile with axial sections and radial sections.

17. The brake actuator unit according to claim 11, wherein the brake actuator unit has a transmission module, which is coupled to the spindle in terms of drive and is arranged between the strain sensor and the electronics module in the axial direction.

18. The brake actuator unit according to claim 17, wherein the transmission module has a ring gear and a transmission carrier having a receptacle, in which the connecting device is arranged with positive engagement, wherein the ring gear is connected by a press fit to the transmission carrier, wherein the connecting device is clamped between the ring gear and the transmission carrier in the axial direction and/or in the radial direction.

19. The brake actuator unit according to claim 1, wherein the strain sensor has a positioning contour, which is in positive engagement with a complementary positioning contour on the outer circumference of the axial section.

20. A strain sensor for a brake actuator unit, comprising a spindle, a brake piston coupled to the spindle, a spindle bearing, which receives the spindle and absorbs axial reaction forces of the spindle during actuation of the brake, and a cup-shaped brake piston bearing section, which has a circumferential wall and a base, against which the spindle bearing is supported axially during the actuation of the brake, wherein the strain sensor has at least one sensor element, which is arranged on an outer circumference of an axial section of the circumferential wall and is configured to detect a strain of the axial section in a circumferential direction.

21. The strain sensor according to claim 20, wherein the strain sensor has an electrical terminal, which is connected in a signal-transmitting manner to the at least one sensor element.

22. The strain sensor according to claim 21, wherein the strain sensor has a contacting hoop which is annular, at least in some section or sections, and which extends in the circumferential direction around the axial section, wherein the contacting hoop has a terminal section having the electrical terminal and, on an inner circumference, a contact section with electrical contacts, via which the electrical terminal is connected in a signal-transmitting manner to the at least one sensor element.

23. The strain sensor according to claim 22, wherein the contacting hoop is prestressed in the circumferential direction in such a way that the contacting hoop is pressed radially against the axial section.

24. The strain sensor according to claim 22, wherein the contacting hoop has, in the circumferential direction (U), a gap which separates a first circumferential end from an opposite second circumferential end, wherein the contacting hoop has a connecting element, which connects the first circumferential end to the second circumferential end in the circumferential direction.

25. The strain sensor according to claim 21, wherein the strain sensor has a flexible cable section, which extends in the circumferential direction around the axial section, at least in some section or sections, wherein the flexible cable section has electrical leads with electrical contacts, via which the electrical terminal is connected in a signal-transmitting manner to the at least one sensor element.

26. The strain sensor according to claim 25, wherein the at least one sensor element has electrical pin contacts, and the flexible cable section has a complementary flat socket with the electrical contacts, wherein the pin contacts and the flat socket form a plug-in connection.

27. An electromechanical brake having an electric motor for actuating the brake, which motor is coupled in a torque-transmitting manner to the spindle, having a brake actuator unit according to claim 1.
